(19) United States
(12) Patent Application Publication
(10) Pub. No.: US 2021/0103972 A1
(43) Pub. Date: Apr. 8, 2021

(54) TRACKING AND MAINTENANCE ARCHITECTURE

(71) Applicant: Tronair, Swanton, OH (US)

(72) Inventors: Eric Baal, Chicago, IL (US); Rick Agnor, Aledo, TX (US)

(21) Appl. No.: 17/060,484

(22) Filed: Oct. 1, 2020

Related U.S. Application Data
(60) Provisional application No. 62/911,507, filed on Oct. 7, 2019.

(51) Int. Cl. G06Q 30/06; G06Q 10/08; G06Q 10/00; G06Q 30/02; G06F 9/451; G06F 16/955; B64F 5/40

(52) U.S. Cl. CPC G06Q 30/0631; G06Q 10/087; G06Q 30/0623; G06Q 10/20; G06Q 40/04; G06F 9/451; G06F 16/955; B64F 5/40; G06Q 30/0204

(57) ABSTRACT

An architecture for the tracking, maintenance, analysis, and/or trading of assets within the aircraft and/or aviation ground support equipment industry. A method can involve receiving customer data from a wireless portable device; based on the customer data, determining an industry sector; retrieving technician data from a database device of a group of database devices; and facilitating displaying of a web user interface on a display device associated with the wireless portable device based on the technician data.

### CROSS REFERENCE TO RELATED APPLICATIONS

This application claims priority to Provisional Application No. 62/911,507 filed Oct. 7, 2019, which is hereby incorporated by reference.

### TECHNICAL FIELD

The disclosed subject matter provides a tracking and maintenance infrastructure, and in particular an aircraft and/or aircraft ground support equipment (GSE) tracking, maintenance, and/or trading architecture applicable within the aviation industry.

### BACKGROUND

Currently, in the aircraft and aircraft ground support equipment tracking, maintenance, and/or trading arena, databases and all data contained in those databases are typically proprietary and generally are not shared amongst industry participants.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

In one embodiment, described is an aircraft and/or aircraft ground support equipment processing device, comprising a processor and a memory that stores executable instructions that, when executed by the processor, facilitate performance of operations, comprising: receiving customer data from a wireless portable device; based on the customer data, determining an industry sector; retrieving technician data from a database device of a group of database devices; and facilitating displaying of a web user interface on a display device associated with the wireless portable device based on the technician data.

In another embodiment, described are methods for processing aircraft and/or aircraft ground support equipment data, involving receiving, by a system comprising a processor, customer data from a wireless portable device; based on the customer data, determining, by the system, an industry sector; retrieving, by the system, technician data from a database device of a group of database devices; generating, by the system, a web user interface based on the technician data; and facilitating displaying, by the system, the web user interface on a display device associated with the wireless portable device.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is an illustration of a system for providing a tracking, maintenance, analysis, and/or trading architecture, in accordance with aspects of the subject disclosure.

FIG. 2 is a further depiction of a system for providing a tracking, maintenance, analysis, and/or trading architecture, in accordance with aspects of the subject disclosure.

FIG. 3 provides illustration of an additional system providing a tracking, maintenance, analysis, and/or trading architecture, in accordance with aspects of the subject disclosure.

FIG. 4 provides illustration of a flow chart or method for the provision of a tracking, maintenance, analysis, and/or trading architecture, in accordance with described embodiments of the subject disclosure.

FIG. 5 provides additional illustration of a flow chart or method for the provision of a tracking, maintenance, analysis, and/or trading architecture, in accordance with described embodiments of the subject disclosure.

FIG. 6 is a block diagram of an example embodiment of a mobile network platform to implement and exploit various features or aspects of the subject disclosure.

FIG. 7 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

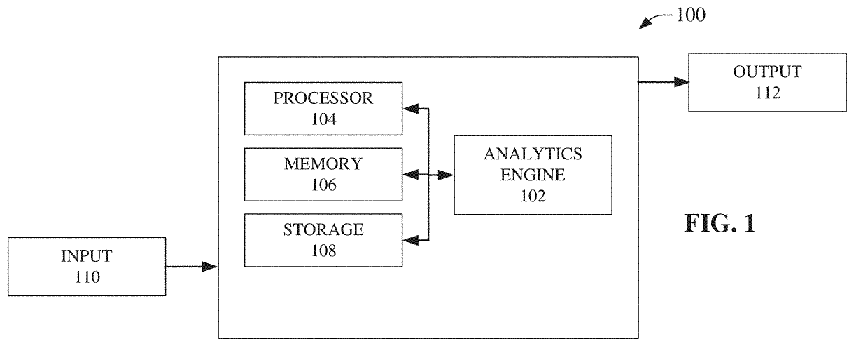

With reference to the Figures, FIG. 1 illustrates a system 100 for the provision of a tracking and maintenance system, in accordance with various embodiments. System 100 in the context of aircraft and/or aircraft ground support equipment (GSE) improves fleet performance from a reliability, uptime, and/or financial perspective. System 100 achieves the foregoing by providing aircraft and/or aircraft ground support equipment personnel, such as aircraft and/or aircraft ground support equipment maintenance technicians, with an easy system that can be functional on devices/apparatuses (e.g., handheld devices, cellular devices, mobile devices, personal digital assistant (PDA) devices, laptop devices, Smartphone devices, notebook computers, and the like) comprising at least a processor and/or that can be communicatively coupled to devices/apparatuses that can comprise one or more processors. Typically, the devices/apparatuses can also have wired and/or wireless communication facilities/functionalities to allow system 100 to functionally communicate with one or more database devices of various groupings of database devices (not shown).

In accordance with various embodiments, system 100 can comprise analytic engine 102 that can be coupled to a processor 104, memory 106, and storage 108. Analytic engine 102 can be in communication with processor 104 for facilitating operation of computer or machine executable instructions and/or components by analytic engine 102, memory 106, for storing data and/or the computer or machine executable instructions and/or components, and storage 108 for providing longer term storage of data and/or machine and/or computer readable instructions. Additionally, system 100 can also receive input 110 for use, manipulation, and/or transformation by analytic engine 102 to produce one or more useful, concrete, and tangible result, and/or transform one or more articles to different states or things. Further, system 100 can also generate and output the useful, concrete, and tangible results and/or the transformed one or more articles produced by analytic engine 102 and output as output 112.

System 100, for purposes of elucidation, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing machines and/or databases, laptop computers, notebook computers, desktop computers, cell phones, smart phones, consumer appliances and/or instrumentation, industrial devices and/or components, hand-held devices, personal digital assistants, multimedia Internet enabled phones, multimedia players, and the like.

Analytic engine 102 can facilitate the collection of data from qualified technical maintenance personnel, facilitate collating, sorting, ordering, and ranking of the collected data based, for example, on various collation, sorting, ordering, and ranking schemes and/or methodologies, and can facilitate generation and/or creation of report data based on the collated, sorted, ordered, and/or ranked data. As will be appreciated by those of ordinary skill, multiple keys (and/or keyword alphanumeric strings) can be also utilized in the collation, sorting, ordering, and/or ranking of the collected data as well as in the creation and/or generation of the report data. The multiple keys and/or keyword alphanumeric strings can, for example, be used in order to identify and/or select data as a function of appropriate keys and/or alphanumeric keyword combinations.

The generated and/or created report data can be used for purposes of analysis to identify trends, to provide prognoses, for example, of impending failures in equipment and/or constituent components of equipment, to provide one or more ad hoc online marketplaces for the acquisition of new equipment and/or new component parts and/or one or more ad hoc business to business forums for the disposal of old equipment and/or component parts for recycling and/or disposal. Additionally, the generated and/or created report data, together with artificial intelligence components with appropriate training sets and/or adaptive learning with continuous feedback, can be used to provide training for personnel to beneficially use and/or repair of equipment. The generated and/or created report data can also be used to reduce costs, improve efficiency of the commercial operation, and/or improve revenue flow. In regard to reducing costs, improving efficiencies, and/or improving revenue flows, the artificial intelligence components and machine learning aspects described herein can be used to facilitate and/or effectuate these goals, wherein cost benefit analyses can be performed wherein costs associated with pursuing a selected or identified course of action can be weighed against the benefits of not pursuing the selected or identified course of action. Similarly, cost benefit analyses can be performed to determine and attain Pareto optimal solutions and/or Pareto optimal efficiencies in regard to the aforementioned goals.

In accordance with various embodiments analytic engine 102 can be implemented as software as a service (SaaS). Typically SaaS makes the system easy to install and manage, reducing information technology (IT) overheads. Further, under these embodiments, the system can be universally accessible on one or more disparate devices, such as user equipment devices, mobile devices, access point devices, Smartphone devices, small form factor devices, desktop devices, tablet computing devices, handheld devices, server class computing machines and/or databases, laptop computer devices, notebook computer devices, desktop computer devices, cell phone devices, commercial and/or consumer appliances and/or instrumentation, industrial devices and/or components, personal digital assistants, multimedia Internet enabled phones, Internet enabled devices, multimedia players, telemetry and/or telematic devices, aeronautical/avionic devices associated with, for instance, orbiting satellites and/or associated aeronautical vehicles, and the like. As will be appreciated, the one or more disparate devices can generally have the facilities and/or functionalities to communicate (e.g., via wired and/or wireless modalities) with network devices of groupings of networked devices (e.g., server class devices, database devices, backup server devices, cellular infrastructure devices, access point devices, base station devices, . . . ).

Analytic engine 102 can provide maintenance and service personnel, such as GSE technicians, a platform to create or enter work order data for repair to equipment, order constituent components for repair of the equipment, enter hours worked in repairing the equipment, etc. In accordance with these embodiments, analytic engine 102 can also facilitate overview by supervisory and/or management personnel to ensure timely completion of repairs to equipment, and that equipment is repaired to at least meet or exceed industry recognized technical standards. In furtherance of the foregoing, various tool user interfaces, dashboard user interfaces, etc. can be generated and displayed for personnel (e.g., apprenticeship grade, technician grade, supervisory grade, management grade personnel) to facilitate and/or effectuate the foregoing. Through the various generated user interfaces (UIs) bottlenecks in parts and component supply chains, vendor timeliness, technician productivity can be highlighted, managed, minimized, and/or ameliorated. Further, through use of the generated UIs parts trend analysis can be performed, wherein inordinate wear and tear (e.g., over and above typical wear and tear), unexpected parts failures, etc. can be identified with regard to parts and appropriate remedial measures implemented to rectify any identified issues.

In accordance with various embodiments, analytic engine 102 can include tracking functionalities and/or facilities wherein purchase orders, can be fulfilled and/or generated for equipment and/or constituent parts and/or services. Additionally and/or alternatively, analytic engine 102 can comprise invoice generating aspects that can facilitate invoicing of customers for equipment and/or parts. Analytic engine 102 thus can effectuate just-in-time inventory practices that can minimize business costs involved with warehousing superfluous (overstock) parts and/or equipment. Analytic engine 102 can also facilitate supply chain integration to allow monitoring of the movement of parts through the supply chain network—from parts vendor to end user.

In the context of invoicing customers for servicing GSE and for parts and/labor, analytic engine 102 can generate individuated invoices for customers and/or for internal tracking. Invoices (or invoice data) can comprise details such as parts cost data, labor cost data (e.g., hours spent on repairing a particular GSE or a fleet of GSE), shipping cost data, tax data, and/or additional charges/fees.

Analytic engine 102 can also create default hourly billing rates, minimum hours for repair of GSE or fleets of GSE based on, for instance, input from trend analysis components, artificial intelligence components, machine learning components, data analytics components, and the like. Further analytic engine 102, based at least in part on input received from at least the trend analysis components, artificial intelligence components, machine learning components, data analytics components, can also generate default overtime rate data, parts markup cost data, outside labor cost data, outside parts markup data, shop supply data, and miscellaneous charge data. The foregoing generated data can be continuously adjusted and/or reviewed, and can appropriately be updated in a timely manner.

Analytic engine 102 can also use visual representations of data in machine readable form, such as two dimensional (2-D) bar codes, three dimensional (3-D) bar codes, Quick Response (QR) codes, and the like, attached to GSE assets and/or associated with individual constituent parts of GSE to scan and commence work. Additionally, geolocation data, geographical coordinate data, can also be used with equal facility to locate and identify GSE assets and to commence work. As will be appreciated by those of ordinary skill in the art, data associated with visual representations of data in machine readable form, such as supplier data, model number, parts data, vendor data, cost data, health and safety data, environmental assessment data, hazardous material data, . . . , can also be used by other disclosed and/or described components set forth herein. For instance data associated with visual representations of data in machine readable form can be used by trend analysis components to track trends in failure rates associated with a particular part. Trend analysis components can also be used to track information in regard to timeliness of suppliers in supplying/delivering GSE constituent parts, reliability of parts supplied based for example, on vendor data, conformance of supplied to technical standards, etc.

Analytic engine 102 can also generate reports that can aid in managing key performance indicators (KPIs) and achieving production and/or financial goals. Analytic engine 102 can generate standard reports, generate third party customer invoicing, provide analysis to determine the true costs of equipment ownership, and facilitate assistance with asset management (e.g., GSE asset management) and right sizing of equipment for a particular purpose. Additionally, analytic engine 102 can provide reports that can facilitate determination of technician productivity and identification of preventive maintenance opportunities. For instance, a data analysis component of analytic engine 102 can enable an unlimited combination of equipment, station, technician, and/or date filters to generate reports that can, for example, be an intuitive and/or interactive pie chart depiction that end users can use to drill down into more specific data. Line charts can also be generated wherein the generated line charts can provide trend analysis that can be useful in uncovering potential issues in regard, for example, with supply chain management (e.g., delays, bottlenecks, etc.). Further, data used by the data analysis component associated with analytic engine 102 can also be used to create reports that can be displayed immediately on touch screen devices (and/or virtual reality devices) so that users can interact directly with the generated reports. It should be noted in regard to the foregoing that reports generated by analytic engine 102 can be automatically created based on a determined or determinable schedule. For example reports can be generated and emailed on an hourly basis, daily basis, weekly basis, every fortnight, monthly, quarterly, semi annually, annually, etc. Report data (e.g., data used to generate individual reports) can be stored in one or more machine readable format, such as a spreadsheet format, word processing document format, portable document format (PDF), comma separate text, etc. As will be appreciated by those having ordinary skill in the art, depending on (e.g., based on, as a function of, and/or in response to a defined or definable security level) the sensitivity of the report data, such report data can be encrypted using one or more data encryption formats.

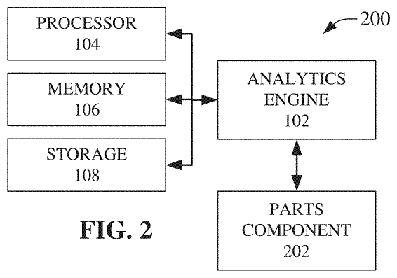

FIG. 2 provides additional detail in regard to system 100, now depicted as system 200. As illustrated, system 200 can comprise parts component 202 that can be communicatively coupled to analytic engine 102, processor 104, memory 106, and storage 108. In various embodiments, parts component 202, in collaboration with one or more analytic engine 102, processor 104, memory 106, and storage 108, can perform part component analysis by aggregating data and information from one or more customer database device or a group of customer database devices. The aggregation of data and information can be performed based, for example, on industry data (e.g., is the customer associated with the aviation industry sector, avionic business sector, automotive business sector, trucking business sector, regional transportation business sector, . . . ). For example, as a function of customer data, parts component 202 can automatically determine within which industry sector the customer should be classified into, and can provide the customer access to a general industry database device of a grouping of general industry database devices. Parts component 202, based on customer data can also provide the customer access to customized customer specific database devices (e.g., database devices that are specific to individual customers).

Parts component 202 can analyze part information data (e.g., associated with GSE), summarize the part information data, and normalize the part information into common components. While the summarization and normalization of part information data can be challenging as different customers can have disparate naming conventions for identical and/or similar parts, parts component 202 in conjunction with, for instance, machine learning components, artificial intelligence components, and the like, can standardize the part information data into an appropriate data structure, such as a list, and thereafter provide mapping between the standardized part information data and the naming conventions of the customer. It should be noted in this regard since customer naming conventions can be fluid over time and since the standardized names of parts can change periodically, parts component 202 can over defined or definable time periods update the mapping between the standardized part information and the naming conventions supplied by the customer.

Parts component 202 can also classify or group part information data based on GSE vehicle type, vehicle make, vehicle model, and/or vehicle engine type into a common naming convention. Additionally, parts component 202 can handle any currency conversions between disparate currencies.

Parts component 202 can also dispatch part recommendations to customers. These recommendations can be based on an analysis of parts that the customer is currently associated with in the customer specific database device. Parts component 202 can determine whether or not a part is currently included in a customer specific database device and in response to determining that a particular part is not included in the customer specific database device, can dispatch a part recommendation to the customer. Parts component 202 can base recommendations to customers on parts that meet or surpass determinable or determined reliability threshold values. The reliability threshold value can be determined, for example, as a percentage of percentages, a weighted mean score, and the like. Data that can be used to determine the reliability threshold value can comprise a source weighting based, for example, on customer expectation feedback data in regard to parts, days installed to replacement values, hours installed to replacement values, fill rates (e.g., based on summarized supply chain data—is a specific part easily available), etc.

Parts component 202 can also associate industry based image data and/or industry based media data (e.g., audio/visual) with individual parts. The image data and media data can be associated with other data, such determined reliability values, part information data (model number data, serial number data, vendor data, supply chain data, manufacturer data, hazardous material warning data, disposal data [e.g., data pertaining to how parts should be disposed of in conformance with environmental and health and safety standards], warrantee data, etc.), and the like, and persisted as one or more database record to a customer specific database device and/or to a general industry database device.

As will be appreciated by those having ordinary skill in the art, system 200 can be in continuous and/or operative communication with a multitude of data repositories (permanent and/or temporary), such as memory 106, storage 108, groupings of customer specific database devices, groupings of general industry specific database devices, and the like. In some embodiments, some of these data repositories can be associated to form a data warehouse comprising collections of staging database devices, aggregations of database devices that can persist dimensioning data, groups of database devices that can store fact table data, and the like. Data repositories comprising the data warehouse can be used, selectively and/or in various combinations, supply appropriate data to perform data analysis and/or to generate and distribute pertinent reports.

In accordance with some embodiments, parts component 202 can receive (e.g., as input 110) a request for an individual part. The request for the individual part can comprise, for instance, part description, image data (e.g., isometric view data, plan view data, end-view data, . . . ), dimensional data, visual representations of data in machine readable form [e.g., barcode data] associated with the requested part, part number(s) associated with the requested part, vendor data, supply chain data, technical data, . . . . Parts component 202, in response to receiving the request, can determine based on the part description, image pattern concurrence between an individual part and the requested part, fuzzy visual image similarity between the requested part and an individual part, visual representations of data in machine readable form associated with the requested part, part number(s) associated with the requested part, historical part usage trend data, part usage trend within a defined industry data, . . . , can identify, retrieve from one of more database device, and display listings for the requested part. In some embodiments, the request for the individual part can be derived from a work order that can have been displayed on a portable user equipment device or handheld device used be technical personnel.

In accordance with the subject description, in some embodiments a work order can comprise listings of top component failures that provide summarized histories for specific equipment units (e.g., GSE vehicles). The listings can display each individuated component part (e.g., nuts, bolts, motors, timing belts, washers, wiring, wiring harnesses, wiring conduit, rubber tubing, neoprene tubing, etc.) that can comprise a specific equipment unit. Further the listings can display part numbers associated with each individuated component part. The listings can also display average days between parts replacement. Additionally, the listings can also display industry specific parts and/or component that can be used as alternatives to a particular requested part. The display of alternative industry specific parts and/or components can lead to potential monetary gains for customers using system 200. It should be noted in the context of alternative industry specific parts, these parts will be those that meet and/or exceed industry averages in relation parts longevity and that are cost beneficial to the customer.

Further, in accordance with various other embodiments, a work order can comprise listings of component histories. The listings of component histories can be an ordering or ranking of component parts ranked or ordered, for instance, by part number, or by durability of part. Further orderings and/or rankings can be based, for instance, on a specific component part, by identified equipment unit (e.g., GSE vehicle), by equipment unit type—useful when the customer has fleets of similar GSE vehicles, or by equipment manufacturer (e.g., GSE vehicles manufactured by a common manufacturer or GSE vehicles manufactures to conform to one or more technical specification). The ordering or ranking, as will be appreciated by those of skill in the art, can be effectuated using various combinations and/or permutation of ranking criteria. For instance, ranking and/or ordering by equipment unit type and equipment manufacturer, ranking and/or ordering by equipment manufacturer and specific component part, ranking and/or ordering based on failure rates of specific component parts, equipment unit type, and component part manufacturer data, etc. Such ordering and/or ranking can include using threshold values, such as industry standard average values, to aid in identifying component parts and/or equipment unit types that can increase the overall reliability of GSE equipment. Further, orderings and/or rankings can include using component replacement averages to facilitate an understanding of the various costs associated with maintaining assets (e.g., GSE vehicles) over a defined or definable duration of time, and/or the relative costs and/or benefits between disparate GSE vehicles from disparate manufacturers, and/or disparate GSE vehicles from the same manufacturer (e.g., between different model variants of vehicle types from the same vehicle manufacturer).

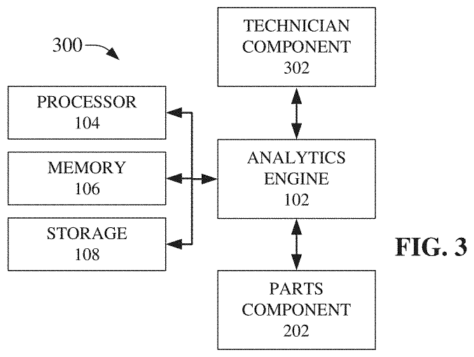

Turning now to FIG. 3 provides additional detail in regard to system 200, now depicted as system 300. As illustrated, system 300 can comprise technician component 302 that like parts component 202 can be communicatively coupled to analytic engine 102, processor 104, memory 106, and storage 108. In various embodiments, technician component 302, in collaboration with one or more analytic engine 102, processor 104, memory 106, and storage 108, can generate and maintain one or more online fora to facilitate asset management and maintenance of GSE vehicles, for example.

Technician component 302 can use aggregations of data and information from one or more disparate customer database devices and different collections of customer database devices to provide a community online presence, wherein the community online presence can comprise a multitude of different industry customers (e.g., customer A from an first industry grouping such as aviation, customer B from a second industry grouping such as railroads, customer C from a third industry grouping such as trucking, etc.). In various embodiments, the community online presence can also comprise a plurality of disparate customers from a single industry sector (e.g. customer A, customer B, customer C, . . . can each belong to the regional public mass transit sector, wherein each of the customers can have ownership or control of a multitude of disparate vehicles—fleets of rolling stock, buses, street cars, and associated equipment for the specific maintenance of each of the fleets, such as cleaning vehicles, vehicles for the transportation of technical personnel to the site of a breakdown of individual assets in the fleet, and the like).

Technician component 302 can allow technicians from various customers to collaborate with one another in reporting various technical issues that they may have encountered and their solutions in overcoming those technical issues. Technician component 302, for example, can establish and setup an online forum for technicians dealing with a specific type, make, and/or model of GSE asset being used by different companies within the industry. The online forum can then be used by technicians to raise and discuss technical issues, trends, etc. that can arise (or have arisen in the past) in regard to servicing the specific type, make, and model of GSE asset. The online forum provides a single site for technicians servicing specific types, makes, and models of GSE assets to exchange technical data with one another and to resolve issues more expeditiously.

In order to facilitate and/or effectuate use of online fora, technician component 302, in response to receiving data associated with a work order and/or based on the data associated with the work order, can present a technician associated with the work order with one or more screens (e.g., generated user interfaces) that allow the technician to search online fora for technical data that can aid in remedying problems with vehicles for which the work order was generated, and to which the technician has been assigned to work. The work order in some embodiments can be associated with a specific asset. For example, the specific asset can be identified based on vehicle type, vehicle make, vehicle model, engine type, chassis type, . . . . Generally, the online fora in some embodiments can allow technicians to conduct a search for listings of part components associated with the specific asset included in the work order. Typically, the part components can comprise engine components, accessory components, suspension components, and the like.

Technician component 302 can facilitate filtered searches of online fora. For example, technician component 302 can facilitate a search of one or more online forum based on filter categories such as “across an industry,” “across a specific company within an industry,” “within databases associated with the company that generated the work order,” “within work orders that have been associated with a particular technician or assigned to a particular technician,” “within work orders on which the assigned technician is currently working and to which the assigned technician has entered preliminary (draft) notations and/or queries,” etc.

In response to searches of online fora, technician component 302 can collate and/or compile listings that can satisfy the filter categories. For instance, technician component 302 can collate and/or compile listings based on vehicle type, vehicle make, vehicle model, model type and the like. Generally, data relating to vehicle type, vehicle make, vehicle model, model type, and the like can be derived from the work order.

Technician component 302 can provide ranked and/or ordered listings wherein the ranking and/or ordering can be based on company specific filters, wherein company administrators can classify or categorize certain data as: generally available (e.g. PIN—allow access to everyone within the online forum); proprietary company specific data generally available to a constrained and select grouping of technicians working within the company (e.g., PRIORITIZE—allow access to a limited list of technicians working within a company specific portion of the online forum); and/or proprietary company specific data available to a very select group of technicians.

As noted above, access to the many database devices and/or online fora accessible by system 300 through technician component 302 can be via work orders. Nevertheless, system 300 is not necessarily so limited. Access to the many database devices and online fora can be accessed based on other disparate criteria, such as vehicle type, vehicle make, vehicle model, and/or engine type.

In some embodiments, technician component 302 can provide a lexicon of synonyms and/or nomenclature that can be used to ensure that there is a commonality of terminology. For instance, one company can refer to a GSE asset as being a “Bag Tug,” while another company can refer to the same or similar GSE asset as being a “Baggage Tractor.” Technician component 302 can therefore ensure that there is, and can impose, a commonality of terminology between disparate names for identical or similar GSE asset, GSE component part, and/or tool. One way that such a commonality of terminology can be imposed by system 300 can be through use of mappings between synonyms, e.g., “Bag Tug” can be mapped to “Baggage Tractor,” and “Baggage Tractor” can be mapped to “Bag Tug,” to indicate that “Bag Tug” and “Baggage Tractor” can refer to identical (or similar) assets. Similar mappings can be effectuated in regard to parts components (e.g., “starter” or “alternator”), vehicle types, vehicle makes, vehicle models, engine types, fuel types (e.g. “petrol,” “gas,” “diesel,” “electric,” “fuel,” . . . ). In facilitating construction of such a lexicon of mappings, system 300 can use one of more data structure, such as arrays, linked lists, doubly linked lists, hierarchical data structures (e.g., tree structures), clusters, etc.

Access to system 300 and its functionalities and/or facilities can require the imposition of security aspects. Thus, in accordance with various embodiments and to gain access to technician component 302, system 300 can impose restrictions of users (e.g., administrative personnel, management personnel, technicians, etc.) that can be accorded access to technician component 302 and/or to data persisted to the various underlying database devices. In accordance with some embodiments, system 300 can impose restrictions to access technician component 302 based at least in part on whether or not a technician is associated with a subscribing company. For instance, technician A can be associated with company A and technician B can be associated with disparate company B. System 300 can therefore provide, through functionalities and/or facilities supplied by technician component 302, technician A with access to data and/or databases associated solely to company A. Similarly, in regard to technician B system 300 can provide access to data and/or database associated solely with company B. In these instances, technician A and technician B can have access solely to company specific technician tips (e.g., technician A will only be provided access to company A's data and/or databases and technician B will only to provided access to company B's data and/or databases).

Access to data and databases specific to a defined company (e.g., company A or company B) can provide technicians with the ability to add, edit, and/or delete technical tips based on criteria, such work order to which the technician has been assigned. Further technicians, via technician component 302, can publish technical tips so that these published technical tips can be available in, for example, one or more company specific online forum. Technicians, via technician component 302, can also annotate technical tips with images and/or media, such as photographs, videos, technical documentation, alternative parts (other than original equipment manufacturer (OEM) parts) that can have been used to remedy problems outlined in the work order, other notations that the technician (and/or other technicians) may find beneficial to rectify problems in the future, and the like. In regard to term “work order” it should be noted, without limitation or loss of generality, for the purposes of this disclosure a “work order” can refer to all method of entering data, for example into “Equipment” and “Master Parts Lists” displayed entry fields or entry tabs.

In accordance with one or more embodiments, administrative personnel can impose restrictions of the technical tip data. For instance, administrative personnel can categorize the technician tip data as being generally available to anyone in a company; proprietary company specific data generally available to a constrained and selected grouping of technicians working within the company; and/or proprietary highly confidential company specific data available to a very select group of technicians.

Technician component 302 can allow users with proper access credentials access to add technician tip data and/or to access fields that can comprise technician tip data. In accordance with embodiments, technician tip data can comprise fields including, for example, title field data comprising first free flowing text data; subtitle field data comprising second free flowing text data; summary field data comprising third free flowing text data; failure type field data comprising first preset list data; relevance field data comprising second preset list data; and recommendation data comprising one or more of fourth free flowing text data and/or third preset list data. In relation to the first preset list data this preset list data can comprise items representing, for example: “normal wear and tear,” “early failure,” and/or “other.” In relation to the second preset list data this preset list data can comprise items representing, for instance: “all models,” “this engine,” “this year,” and/or “this engine and year.” With regard to the fourth free flowing text data this free flowing text data can represent recommendations represented as data points that can be used to recommend service bulletins, better parts/components, additional inspections. The fourth free flowing text data can be aggregated based on respective customer identity (e.g., company A, company B. company C, . . . ). These aggregations can better help customers understand at a high level what is happening on the shop floor. In relation to the third preset list data this list data can comprise items representing “add to preventive maintenance—recommend an inspection to aid in the resolution of an issue,” “add to service bulletin—recommend a special service bulleting to be created for this type of asset across all cities to solve the issue,” “notify OEM—recommend a notification to the manufacturer of the problem,” “inspect pre-delivery—recommend a specific inspection that should be done when an asset comes in,” “replace component—replace a specific part component,” “replace part—a specific part is bad and should be replaced,” “recommend part—what part should be installed,” and “other—text allowing the user to specify a recommendation.”

In accordance with various embodiments, technician component 302 can provide functionalities to facilitate the provision of feedback about technician tip data. In accordance with these embodiments, technician component 302 can permit other users of system 300 to rank individual technician tip data based on one or more ranking metrics. For example, ranking data can include whether or not particular technician tip data is helpful, whether or not the technician tip data has sufficient detail, and/or comments as to whether the technician tip data is fit for purpose.

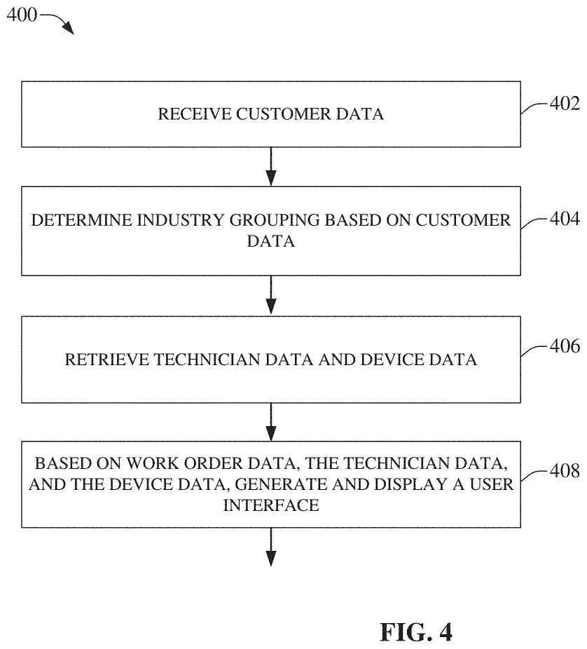

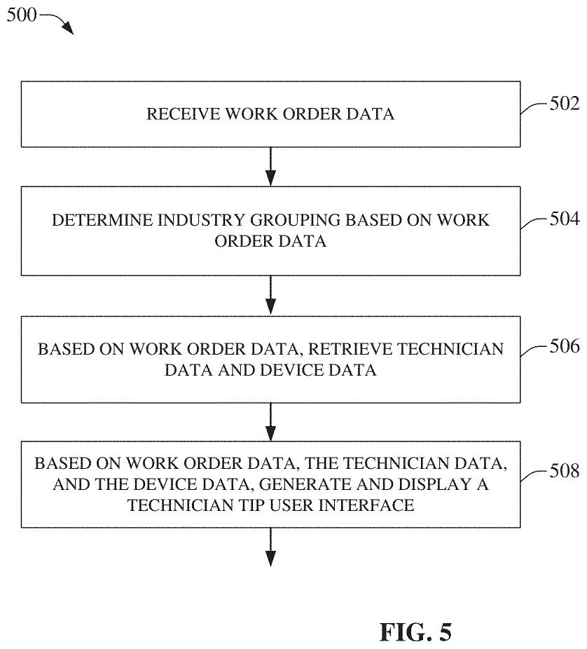

In view of the example system(s) described above, example method(s) that can be implemented in accordance with the disclosed subject matter can be better appreciated with reference to the flowcharts in FIGS. 4-5. For purposes of simplicity of explanation, example method disclosed herein is presented and described as a series of acts; however, it is to be understood and appreciated that the disclosure is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, the disclosed example method can be implemented in combination with one or more other methods, to accomplish one or more aspects herein described. It should be further appreciated that the example method disclosed throughout the subject specification are capable of being stored on an article of manufacture (e.g., a computer-readable medium) to allow transporting and transferring such methods to computers for execution, and thus implementation, by a processor or for storage in a memory.

FIG. 4 illustrates a method 400 for the provision of a tracking, maintenance, and/or trading architecture, in accordance with described embodiments of the subject disclosure. Method 400 can commence at act 402 wherein system 100 can receive customer data. Customer data can include data representing a specific industry within which the customer operates, such as aviation, railroads, mass transit, etc. and/or technician specific data, such as user name, password, and the like. At 404 based on the customer data system 100 can determine within which industry grouping the customer should belong. At 406 based on the customer data and the industry grouping, technician data can be retrieved for one or more database device of a group of database devices. At 408 based on work order data that can have been determined based, for example, on the technician data and device data that can have been elicited as customer data, system 100 can generate and display a user interface based on the device data.

In accordance with one or more aspects, the user interface can allow a user to interact with databases comprising industry data, technical tip data representing data obtained from qualified technical personnel, manufacturer service bulletin data, and/or warranty data associated with parts components. In various embodiments, system 100 can generate alert data based in part on manufacturer service bulletin data, warranty data, and or technical tip data. In accordance with other embodiments, an online marketplace can be established and maintained in order to buy and/or sell parts.

FIG. 5 illustrates a method 500 for the provision of a tracking, maintenance, and/or trading architecture, in accordance with described embodiments of the subject disclosure. Method 500 can commence at act 502 wherein work order data can be received. At 504 based on the work order data an industry grouping can be determined. At 506 based on work order data, technician data and portable device data pertaining the portable device that the technician is utilizing can be retrieve, for instance, from the technician and/or from the portable device itself transmitting details about itself. At 508 based on the work order data, the technician data, and the portable device data, system 100 can generate a technician tip user interface that can permit various functionalities and/or facilities as elucidated in regard to system 100, system 200, and/or system 300 above.

It should be realized and appreciated by those of ordinary skill, the foregoing non-limiting example use application(s) are merely illustrations of a use to which the disclosed and described solution can be applied and thus are provided solely for the purposes of exposition. The described and disclosed subject matter is therefore not limited to the foregoing example application(s), but can find applicability in other more generalized circumstances and use applications.

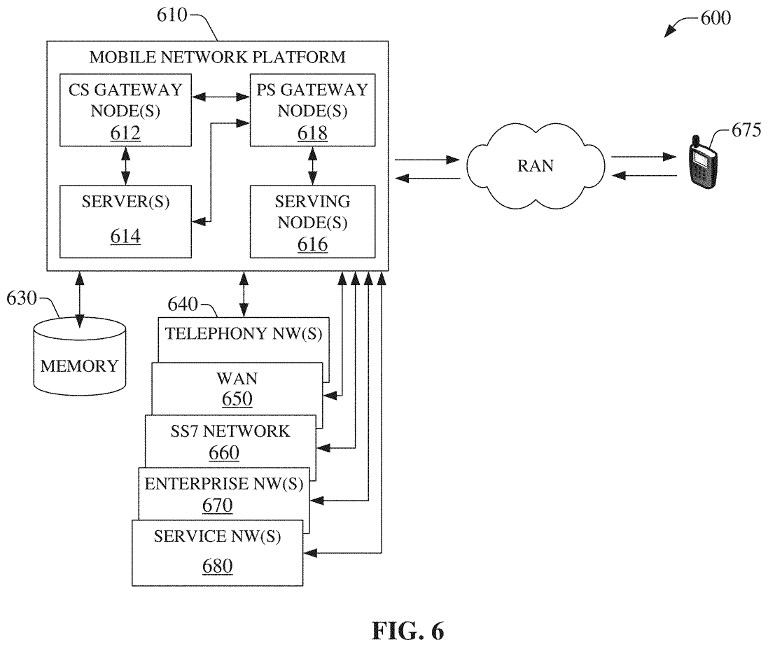

FIG. 6 presents an example embodiment 600 of a mobile network platform 610 that can implement and exploit one or more aspects of the disclosed subject matter described herein. Generally, wireless network platform 610 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 610 can be included in telecommunications carrier networks, and can be considered carrier-side components as discussed elsewhere herein. Mobile network platform 610 includes CS gateway node(s) 612 which can interface CS traffic received from legacy networks like telephony network(s) 640 (e.g., public switched telephone network (PSTN), or public land mobile network (PLMN)) or a signaling system #7 (SS7) network 670. Circuit switched gateway node(s) 612 can authorize and authenticate traffic (e.g., voice) arising from such networks. Additionally, CS gateway node(s) 612 can access mobility, or roaming, data generated through SS7 network 660; for instance, mobility data stored in a visited location register (VLR), which can reside in memory 630. Moreover, CS gateway node(s) 612 interfaces CS-based traffic and signaling and PS gateway node(s) 618. As an example, in a 3GPP UMTS network, CS gateway node(s) 612 can be realized at least in part in gateway GPRS support node(s) (GGSN). It should be appreciated that functionality and specific operation of CS gateway node(s) 612, PS gateway node(s) 618, and serving node(s) 616, is provided and dictated by radio technology(ies) utilized by mobile network platform 610 for telecommunication.

In addition to receiving and processing CS-switched traffic and signaling, PS gateway node(s) 618 can authorize and authenticate PS-based data sessions with served mobile devices. Data sessions can include traffic, or content(s), exchanged with networks external to the wireless network platform 610, like wide area network(s) (WANs) 650, enterprise network(s) 670, and service network(s) 680, which can be embodied in local area network(s) (LANs), can also be interfaced with mobile network platform 610 through PS gateway node(s) 618. It is to be noted that WANs 650 and enterprise network(s) 670 can embody, at least in part, a service network(s) like IP multimedia subsystem (IMS). Based on radio technology layer(s) available in technology resource(s) 617, packet-switched gateway node(s) 618 can generate packet data protocol contexts when a data session is established; other data structures that facilitate routing of packetized data also can be generated. To that end, in an aspect, PS gateway node(s) 618 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 600, wireless network platform 610 also includes serving node(s) 616 that, based upon available radio technology layer(s) within technology resource(s) 617, convey the various packetized flows of data streams received through PS gateway node(s) 618. It is to be noted that for technology resource(s) 617 that rely primarily on CS communication, server node(s) can deliver traffic without reliance on PS gateway node(s) 618; for example, server node(s) can embody at least in part a mobile switching center. As an example, in a 3GPP UMTS network, serving node(s) 616 can be embodied in serving GPRS support node(s) (SGSN).

For radio technologies that exploit packetized communication, server(s) 614 in wireless network platform 610 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 610. Data streams (e.g., content(s) that are part of a voice call or data session) can be conveyed to PS gateway node(s) 618 for authorization/authentication and initiation of a data session, and to serving node(s) 616 for communication thereafter. In addition to application server, server(s) 614 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 610 to ensure network's operation and data integrity in addition to authorization and authentication procedures that CS gateway node(s) 612 and PS gateway node(s) 618 can enact. Moreover, provisioning server(s) can provision services from external network(s) like networks operated by a disparate service provider; for instance, WAN 650 or Global Positioning System (GPS) network(s) (not shown). Provisioning server(s) can also provision coverage through networks associated to wireless network platform 610 (e.g., deployed and operated by the same service provider), such as femto-cell network(s) (not shown) that enhance wireless service coverage within indoor confined spaces and offload radio access network resources in order to enhance subscriber service experience within a home or business environment by way of UE 675.

It is to be noted that server(s) 614 can include one or more processors configured to confer at least in part the functionality of macro network platform 610. To that end, the one or more processor can execute code instructions stored in memory 630, for example. It is should be appreciated that server(s) 614 can include a content manager 615, which operates in substantially the same manner as described hereinbefore.

In example embodiment 600, memory 630 can store information related to operation of wireless network platform 610. Other operational information can include provisioning information of mobile devices served through wireless platform network 610, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 630 can also store information from at least one of telephony network(s) 640, WAN 650, enterprise network(s) 670, or SS7 network 660. In an aspect, memory 630 can be, for example, accessed as part of a data store component or as a remotely connected memory store.

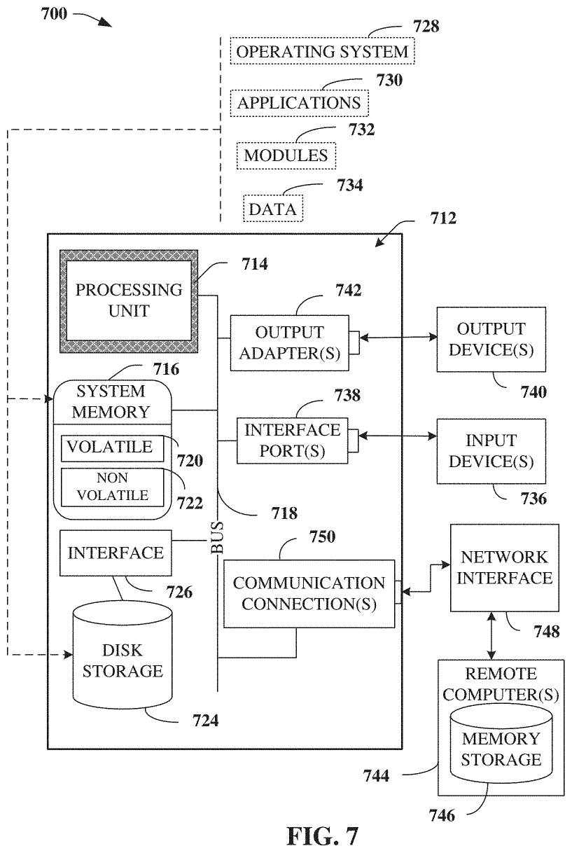

In order to provide a context for the various aspects of the disclosed subject matter, FIG. 7, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 720 (see below), non-volatile memory 722 (see below), disk storage 724 (see below), and memory storage 746 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 7 illustrates a block diagram of a computing system 700 operable to execute the disclosed systems and methods in accordance with an embodiment. Computer 712, which can be, for example, part of the hardware of system 100, includes a processing unit 714, a system memory 716, and a system bus 718. System bus 718 couples system components including, but not limited to, system memory 716 to processing unit 714. Processing unit 714 can be any of various available processors. Dual microprocessors and other multiprocessor architectures also can be employed as processing unit 714.

System bus 718 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 716 can include volatile memory 720 and nonvolatile memory 722. A basic input/output system (BIOS), containing routines to transfer information between elements within computer 712, such as during start-up, can be stored in nonvolatile memory 722. By way of illustration, and not limitation, nonvolatile memory 722 can include ROM, PROM, EPROM, EEPROM, or flash memory. Volatile memory 720 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 712 can also include removable/non-removable, volatile/non-volatile computer storage media. FIG. 7 illustrates, for example, disk storage 724. Disk storage 724 includes, but is not limited to, devices like a magnetic disk drive, floppy disk drive, tape drive, flash memory card, or memory stick. In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to system bus 718, a removable or non-removable interface is typically used, such as interface 726.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. For the avoidance of doubt, the term “computer-readable storage device” is used and defined herein to exclude transitory media. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 7 describes software that acts as an intermediary between users and computer resources described in suitable operating environment 700. Such software includes an operating system 728. Operating system 728, which can be stored on disk storage 724, acts to control and allocate resources of computer system 712. System applications 730 take advantage of the management of resources by operating system 728 through program modules 732 and program data 734 stored either in system memory 716 or on disk storage 724. It is to be noted that the disclosed subject matter can be implemented with various operating systems or combinations of operating systems.

A user can enter commands or information into computer 712 through input device(s) 736. As an example, mobile device and/or portable device can include a user interface embodied in a touch sensitive display panel allowing a user to interact with computer 712. Input devices 736 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 714 through system bus 718 by way of interface port(s) 738. Interface port(s) 738 include, for example, a serial port, a parallel port, a game port, a universal serial bus (USB), an infrared port, a Bluetooth port, an IP port, or a logical port associated with a wireless service, etc. Output device(s) 740 use some of the same type of ports as input device(s) 736.

Thus, for example, a USB port can be used to provide input to computer 712 and to output information from computer 712 to an output device 740. Output adapter 742 is provided to illustrate that there are some output devices 740 like monitors, speakers, and printers, among other output devices 740, which use special adapters. Output adapters 742 include, by way of illustration and not limitation, video and sound cards that provide means of connection between output device 740 and system bus 718. It should be noted that other devices and/or systems of devices provide both input and output capabilities such as remote computer(s) 744.

Computer 712 can operate in a networked environment using logical connections to one or more remote computers, such as remote computer(s) 744. Remote computer(s) 744 can be a personal computer, a server, a router, a network PC, cloud storage, cloud service, a workstation, a microprocessor based appliance, a peer device, or other common network node and the like, and typically includes many or all of the elements described relative to computer 712.

For purposes of brevity, only a memory storage device 746 is illustrated with remote computer(s) 744. Remote computer(s) 744 is logically connected to computer 712 through a network interface 748 and then physically connected by way of communication connection 750. Network interface 748 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 750 refer(s) to hardware/software employed to connect network interface 748 to bus 718. While communication connection 750 is shown for illustrative clarity inside computer 712, it can also be external to computer 712. The hardware/software for connection to network interface 748 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. An aircraft and aircraft ground support equipment processing device, comprising:
a processor; and
a memory that stores executable instructions that, when executed by the processor, facilitate performance of operations, comprising:
receiving customer data from a wireless portable device;
based on the customer data, determining an industry sector;
retrieving technician data from a database device of a group of database devices; and
facilitating displaying of a web user interface on a display device associated with the wireless portable device based on the technician data.

2. The device of claim 1, wherein the web interface is customized based on device data associated with the wireless portable device.

3. The device of claim 1, wherein the database device of the group of database devices is a first database device, and wherein the web user interface provides access to a second database device of the group of database devices.

4. The device of claim 3, wherein access to the first database device is determined based on the technician data.

5. The device of claim 3, wherein access to the second database device is determined based on the technician data and the customer data.

6. The device of claim 3, wherein the customer data represents an industry sector grouping.

7. The device of claim 3, wherein the second database device persists database records representing parts data.

8. The device of claim 7, wherein the parts data is associated with technician tip data representing recommendations and analysis by a technician associated with the technician data.

9. The device of claim 1, wherein the customer data represents work order data.

10. A method for processing aircraft and aircraft ground support equipment data, comprising:
receiving, by a system comprising a processor, customer data from a wireless portable device;
based on the customer data, determining, by the system, an industry sector;
retrieving, by the system, technician data from a database device of a group of database devices;
generating, by the system, a web user interface based on the technician data; and
facilitating displaying, by the system, the web user interface on a display device associated with the wireless portable device.

11. The method of claim 10, wherein the web interface is customized based on device data associated with the wireless portable device.

12. The method of claim 10, wherein the database device of the group of database devices is a first database device, and wherein the web user interface provides access to a second database device of the group of database devices.

13. The method of claim 12, wherein access to the first database device is determined based on the technician data.

14. The method of claim 12, wherein access to the second database device is determined based on the technician data and the customer data.

15. The method of claim 12, wherein the customer data represents an industry sector grouping.

16. The method of claim 12, wherein the second database device persists database records representing parts data.

17. The method of claim 16, wherein the parts data is associated with technician tip data representing recommendations and analysis by a technician associated with the technician data.

18. The method of claim 10, wherein the customer data represents work order data.

19. A machine-readable medium, comprising executable instructions that, when executed by a processor, facilitate performance of operations, comprising:
in response to receiving customer data from a wireless device, determining an industry sector;
retrieving technician data from a database device of a collection of database devices;
generating a user interface based on the technician data and the customer data; and
facilitating displaying the user interface on a display device associated with the wireless device.

20. The machine-readable medium of claim 19, wherein the customer data represents an industry sector grouping.
